(19) United States
(12) Patent Application Publication
(10) Pub. No.: US 2026/0348809 A1
(43) Pub. Date: Nov. 5, 2026

(54) PRESSURE TESTING SYSTEM WITH BLAST-RESISTANT ENCLOSURE AND PIPE CONDITION MONITORING SENSORS

(71) Applicant: Saudi Arabian Oil Company, DHAHRAN (SA)

(72) Inventors: Soon W. Moon, Dhahran (SA); Nayef M. Alanazi, Dammam (SA); Turki A. ALKHALDI, Dammam (SA)

(73) Assignee: Saudi Arabian Oil Company, DHAHRAN (SA)

(21) Appl. No.: 19/194,350

(22) Filed: Apr. 30, 2025

(51) Int. Cl. G01N 3/12

(52) U.S. Cl. CPC G01N 3/12; G01N 2203/0003; G01N 2203/0048; G01N 2203/0064; G01N 2203/0066; G01N 2203/0232; G01N 2203/0274; G01N 2203/0641; G01N 2203/0658

(57) ABSTRACT

An apparatus for pressure testing is disclosed. The apparatus includes a blast-resistant enclosure including multiple layers of material. An armor layer is among the multiple layers of material, and the armor layer is configured to provide structural integrity and impact resistance. A cushion layer is among the multiple layers of material, and the cushion layer is configured to dampen energy. A cover layer is disposed over the other layers of material comprising the blast-resistant enclosure. A pressure testing and condition monitoring assembly is positioned within the blast-resistant enclosure. Methods for pressure testing are also disclosed.

### FIELD OF THE DISCLOSURE

The present disclosure relates generally to the field of pressure testing and safety in high-pressure operations, and more specifically to systems and methods that utilize blast-resistant enclosures and pipe condition monitoring sensors, effectively containing high-pressure releases and flying debris during testing procedures.

### BACKGROUND OF THE DISCLOSURE

Pressure testing in the industrial sector ensures the integrity and safety of pipelines and high-pressure systems. However, traditional methods come with inherent risks, primarily linked to the catastrophic failures that can occur during testing procedures. These failures can lead to explosive releases of pressure and debris, posing substantial threats to both personnel and nearby assets.

The present disclosure is directed to mitigate and resolve these concerns.

### SUMMARY OF THE DISCLOSURE

An apparatus for pressure testing comprises a blast-resistant enclosure comprising multiple layers of material. In some implementations, an armor layer is among the multiple layers of material, and the armor layer is configured to provide structural integrity and impact resistance. In particular arrangements, a cushion layer is among the multiple layers of material, and the cushion layer is configured to dampen energy. In various arrangements, a cover layer is disposed over the other layers of material comprising the blast-resistant enclosure. In one or more implementations, a pressure testing and condition monitoring assembly is positioned within the blast-resistant enclosure.

In one or more variants, the armor layer comprises a material selected from the group consisting of aramid fiber, ultra-high molecular weight polyethylene fiber, polycarbonate, and meshed metal sheets. In particular arrangements, the cushion layer comprises a plurality of pores configured to enhance energy dampening, utilizing a structure selected from the group consisting of honeycomb, cellular foam, and interpenetrating polymer network materials. In one or more variations, the cushion comprises a material selected from the group consisting of rubber and polyurethane.

In some implementations, there are a plurality of blast-resistant enclosures, further comprising at least one test pipe interconnecting at least two of the plurality of blast-resistant enclosures. In particular arrangements, there is a plurality of pipe condition monitoring sensors respectively associated with respective ones of the at least one test pipe. In various arrangements, the pressure testing and condition monitoring assembly further comprises a plurality of pipe condition monitoring sensors, and the pipe condition monitoring sensors are supported by a test pipe, within the enclosure, or both supported by a test pipe and within the enclosure.

In one or more implementations, the pressure testing and condition monitoring assembly further comprises a plurality of pipe condition monitoring sensors, and the pipe condition monitoring sensors comprise one or more acoustic emission sensors configured to detect crack initiation and propagation within the enclosure. In one or more variants, the pressure testing and condition monitoring assembly further comprises a plurality of pipe condition monitoring sensors, wherein the pipe condition monitoring sensors comprise one or more microwave nondestructive testing sensors attached onto, supported by, and/or embedded within the walls of the blast-resistant enclosure, and the microwave nondestructive testing sensors are configured to monitor for defects.

In particular arrangements, there is a rigid frame structure coupled to the blast-resistant enclosure, the rigid frame structure comprising a hollow cylindrical structure extending from within the blast-resistant enclosure to an exterior thereof, and the hollow cylindrical structure is configured to receive a test pipe of one or more different diameters. In various arrangements, the blast-resistant enclosure is lined with a hard casing comprising one of the multiple layers of material, and the hard casing has openings for the insertion and extraction of the test pipe.

A method for conducting a pressure test in an enclosure comprises providing a blast-resistant enclosure made of a multi-layered material comprising an armor layer configured to provide structural integrity and impact resistance, a cushion layer configured to dampen energy, and a cover layer disposed over the other layers of material comprising the blast-resistant enclosure. In some implementations, there is positioning of a pressure testing and condition monitoring assembly within the blast-resistant enclosure. In one or more variations, the pressure testing and condition monitoring assembly is activated.

In particular arrangements, the method further comprises fabricating the armor layer from a material selected from the group consisting of aramid fiber, ultra-high molecular weight polyethylene fiber, polycarbonate, and meshed metal sheets. In various arrangements, the method includes incorporating a cushion layer that comprises pores configured to enhance energy dampening, utilizing a structure selected from the group consisting of honeycomb, cellular foam, and interpenetrating polymer network materials.

In one or more implementations, the method further comprises configuring the cover layer of the blast-resistant enclosure to provide protection against one or more of UV radiation, abrasion, and mechanical damage. In one or more variants, the method includes providing one or more additional blast-resistant enclosures resulting in a plurality of blast-resistant enclosures and interconnecting, via at least one test pipe, at least two of the plurality of blast-resistant enclosures.

In particular arrangements, the method further comprises installing a plurality of pipe condition monitoring sensors within the blast-resistant enclosure and/or supported by the at least one test pipe. In various arrangements, the method includes utilizing a pressure testing and condition monitoring assembly that incorporates a plurality of pipe condition monitoring sensors supported by a test pipe, within the enclosure, or both.

In one or more implementations, the method further comprises detecting, via one or more acoustic emission sensors within the pressure testing and condition monitoring assembly, crack initiation and propagation within the enclosure. In one or more variations, the method further comprises monitoring defects in the enclosure via one or more microwave nondestructive testing sensors embedded within the walls of the blast-resistant enclosure. In some implementations, the method includes accommodating different diameters of test pipes insertable into the rigid frame via a cylindrical rigid frame structure.

The details of one or more implementations are set forth in the accompanying drawings and the description below. Other features will be apparent from the description, from the drawings, and from the claims.

### BRIEF DESCRIPTION OF THE DRAWINGS

The foregoing and other objects and advantages of the present disclosure will become more apparent when considered in connection with the following detailed description and appended drawings in which like designations denote like elements in the various views, in which:

FIG. 1 is a wall structure of a blast-resistant enclosure consistent with one or more embodiments of the present disclosure.

FIG. 2 is another wall structure of a blast-resistant enclosure consistent with one or more embodiments of the present disclosure.

FIG. 3A is a side view of a cylindrical rigid frame composed of longitudinal and circumferential ribs consistent with one or more embodiments of the present disclosure. FIG. 3B is a cross-sectional view of a cylindrical rigid frame composed of longitudinal and circumferential ribs consistent with one or more embodiments of the present disclosure.

FIG. 4A is a side view of a hydrotest pressure testing and condition monitoring assembly consistent with one or more embodiments of the present disclosure. FIG. 4B is a cross-sectional view of a hydrotest pressure testing and condition monitoring assembly consistent with one or more embodiments of the present disclosure.

FIG. 5 depicts a cushion layer in a blast-resistant enclosure consistent with one or more embodiments of the present disclosure.

FIG. 6 depicts a hard case lined with a blast-resistant enclosure, with an armor layer omitted to better show the cushion layer inside, consistent with one or more embodiments of the present disclosure.

FIG. 7A is a side view of a hydrotest pressure testing and condition monitoring assembly with sensors installed onto a test pipe consistent with one or more embodiments of the present disclosure. FIG. 7B is a cross-sectional view of a hydrotest pressure testing and condition monitoring assembly with sensors installed onto a test pipe consistent with one or more embodiments of the present disclosure.

FIG. 8A is a side view of a hydrotest pressure testing and condition monitoring assembly with sensors installed onto walls of an enclosure consistent with one or more embodiments of the present disclosure. FIG. 8B is a cross-sectional view of a hydrotest pressure testing and condition monitoring assembly with sensors installed onto walls of an enclosure consistent with one or more embodiments of the present disclosure.

FIG. 9 is a wall structure of a blast-resistant enclosure with sensors embedded inside the enclosure, consistent with one or more embodiments of the present disclosure.

FIG. 10 depicts an energy dampening honeycomb structure consistent with one or more embodiments of the cushion layer in the present disclosure.

FIG. 11 depicts an energy dampening cellular foam structure consistent with one or more embodiments of the cushion layer in the present disclosure.

### DETAILED DESCRIPTION OF CERTAIN EMBODIMENTS CONSISTENT WITH THE DISCLOSURE

The present disclosure concerns pressure testing apparatuses and methods having a blast-resistant enclosure designed to enhance safety during hydrotesting without necessitating extensive spatial arrangements or additional safety measures. The system comprises a multi-layered enclosure featuring, at least, an armor layer for structural integrity and impact resistance, a cushion layer for energy dampening, and a protective cover layer. This design and structural arrangement effectively mitigates risks associated with high-pressure tests by containing the energy release and debris resulting from component burst incidents. The use of advanced materials such as aramid fiber and ultra-high molecular weight polyethylene in the armor layer, coupled with energy-absorbing materials like Sorbothane in the cushion layer, enables the apparatuses and methods disclosed herein to not only withstand high impacts but also reduce the kinetic energy of flying debris, thereby preventing secondary damage to the test components and ensuring the safety of personnel and nearby assets. In some implementations, the cushion layer also dampens noise coming from burst incidents.

Additionally, some apparatuses and methods consistent with the present disclosure integrate pipe condition monitoring sensors are placeable on a test pipe and within the enclosure. These sensors, comprising, for example, acoustic emission detectors and microwave nondestructive sensors, are configured, such as by code executing in or in coordination with the sensors, to gather data on pipe integrity at various stages of the hydrotest process. This data encompasses crack initiation and propagation, as well as monitoring for defects like delamination and fiber breakage. By analyzing this real-time information, the apparatuses and methods disclosed herein create opportunities for research into pipe fracture mechanisms and structural integrity assessments. In further implementations, one or more high-resolution cameras are installed as well to visually monitor the progress of source or sources of potential structural failures during high-pressure testing.

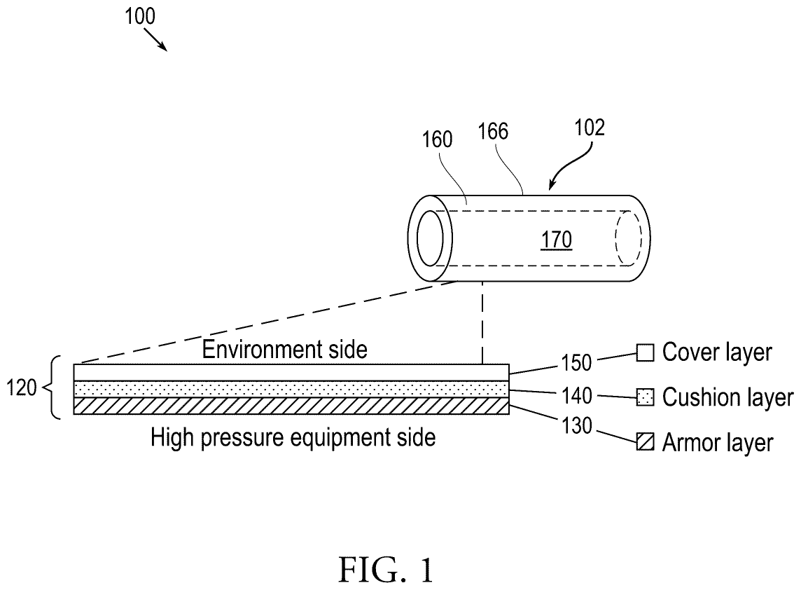

FIG. 1 is a depiction 100 of a wall structure 102 of a blast-resistant enclosure 160 consistent with one or more embodiments of the present disclosure. An apparatus for pressure testing consistent with the present disclosure comprises a blast-resistant enclosure 160 comprising multiple layers 120 of material. In one or more implementations, an armor layer 130 among the multiple layers of material is configured to provide structural integrity and impact resistance. In various arrangements, a cushion layer 140 among the multiple layers of material is configured to dampen energy. In particular arrangements, a rigid frame structure 166 is coupled to the blast-resistant enclosure 160. In one or more variants, a pressure testing and condition monitoring assembly 170 is positioned within the blast-resistant enclosure 160.

In one or more implementations, the armor layer 130 comprises an impact-resistant material selected from the group consisting of aramid fiber, ultra-high molecular weight polyethylene fiber, polycarbonate, and meshed metal sheets (to facilitate penetration of microwave signals from a microwave sensor). In particular arrangements, the cushion layer 140 comprises a plurality of pores configured to enhance energy dampening, utilizing a structure selected from the group consisting of honeycomb, cellular foam, and interpenetrating polymer network materials. In one or more variations, the apparatus further comprises a cover layer 150 disposed over the other layers of material comprising the blast-resistant enclosure 160. The cover layer 150 is configured to provide protection against one or more of the following: UV radiation, abrasion, and mechanical damage.

In some implementations, polymer processing methods are employed in the construction of the multi-layered blast-resistant enclosure 160. In various implementations, one such process is lamination through a calendaring process and co-extrusion. In the calendaring method, individual sheets comprising the armor layer 130, cushion layer 140, and cover layer 150 are passed through rollers, merging them into a single cohesive sheet 120. This method allows for the effective application of adhesive bonding or heat-sealing techniques to secure and bond the individual layers, resulting in a robust wall structure. In some arrangements, co-extrusion is utilized to fabricate multi-layered polymeric films, enabling the simultaneous formation of different layers with desired material properties.

Restated, in some implementations, the armor layer 130 is constructed from high-strength, impact-resistant materials, which include aramid fiber (e.g., Kevlar®), ultra-high molecular weight polyethylene fiber (e.g., Spectra®), polycarbonate, and meshed metal sheet. In particular arrangements, the cushion layer 140 is made of energy-dampening materials such as rubber and polyurethane (e.g., Sorbothane®). To maximize energy dampening in certain implementations, the cushion layer 140 features an internal structure with pores, such as designs like honeycomb, cellular foam, and interpenetrating polymer networks. In various arrangements, the cover layer 150 is formed from materials that provide protection against UV radiation, abrasion, and mechanical damage. By combining one or more energy dampening cushion layers 140 and structural armor layers 130 in sequence, released energy from component failure during pressure testing can be safely contained, achieving the long-sought and surprising result of high-level safety in a cost-effective way.

In some implementations, the wall structure 102 of the blast-resistant enclosure 160 is configured as depicted in FIG. 1. In particular arrangements, the armor layer 130 is positioned on the high-pressure equipment side, while the cover layer 150 is located on the environment side. In one or more implementations, the cushion layer 140 is situated between the armor layer 130 and cover layer 150, serving to absorb high-pressure releases and impact energy from flying debris through material deformation. In various arrangements, if a higher level of protection is required, additional armor and cushion layers can be added in sequence.

With regard to the connection and assembly of the multiple layers 120 within the blast-resistant enclosure 160, in various implementations, these layers 120 are arranged in direct, abutting relationship with one another, ensuring structural integrity and energy absorption. In some implementations, each layer, including the armor 130, cushion 140, and cover layers 150, is securely bonded through one or a combination of the following methods: adhesive bonding, heat sealing, or mechanical fastening. Utilization of such bonding methods results in formation of a unified structural entity. In one or more arrangements, the armor layer 130 provides the foremost protection against impact and high-pressure events, while the cushion layer 140, interposed between the armor 130 and cover layers 140, is designed to deform under stress, dissipating energy and reducing the risk of secondary damage. This layered configuration ensures that the integrity of each layer is maintained under operational conditions, facilitating effective containment of energy release and debris that may arise during pressure testing procedures. In some implementations, the adhesion methods used are tailored to enhance the performance of the materials used.

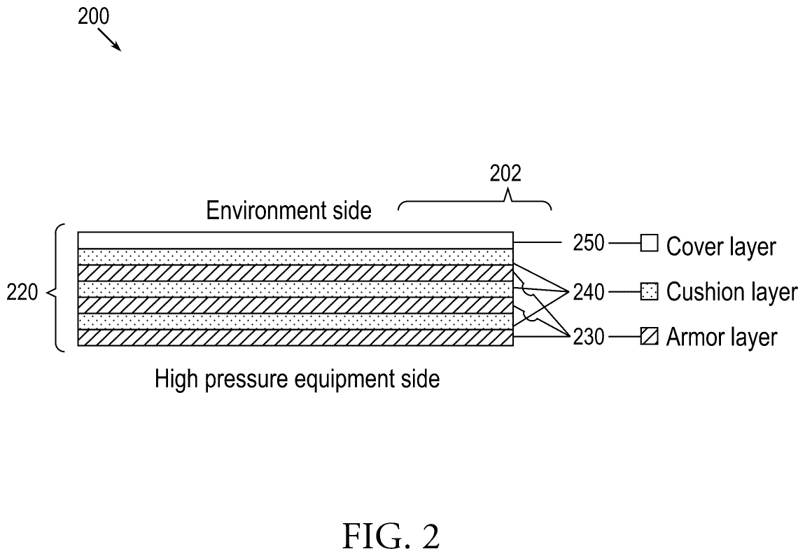

FIG. 2 is another depiction 200 of a wall structure 202 (similar to wall structure 102 in FIG. 1) of a blast-resistant enclosure consistent with one or more embodiments of the present disclosure. The wall structure 202 has multiple internal layers 220. There are three cushion layers 240 (each similar to cushion layer 140 in FIG. 1) and three armor layers 230 (each similar to armor layer 130 in FIG. 1), all encased by a cover layer 250 (similar to cover layer 150 in FIG. 1). Some implementations have even more of each type of layer. In one or more variations, multiple armor layers 230 and cushion layers 240 are incorporated to achieve different degrees of protection as required by a given scenario. In one or more implementations, the blast-resistant enclosure 260 (similar to blast-resistant enclosure 160 in FIG. 1) is affixed to a rigid frame structure, such as rigid frame structure 166 in FIG. 1. In one or more variants, the blast-resistant enclosure 260 is designed as either single-piece or multi-piece constructions.

FIG. 2 illustrates another blast-resistant enclosure consistent with some implementations that incorporates multiple armor layers 230 and cushion layers 240. In particular arrangements, different layers 220 are bonded together to create a robust blast-resistant wall structure 202. In some implementations, the armor layer 230 is embedded within the cushion layer 240, resulting in the armor layer being located on one side and the cushion layer on the opposite side. In one or more variants, an impact-resistant textile sheet is integrated with a rubber sheet through a calendering process and used in conjunction with the layers 220 or enclosure (such as enclosure 160 in FIG. 1).

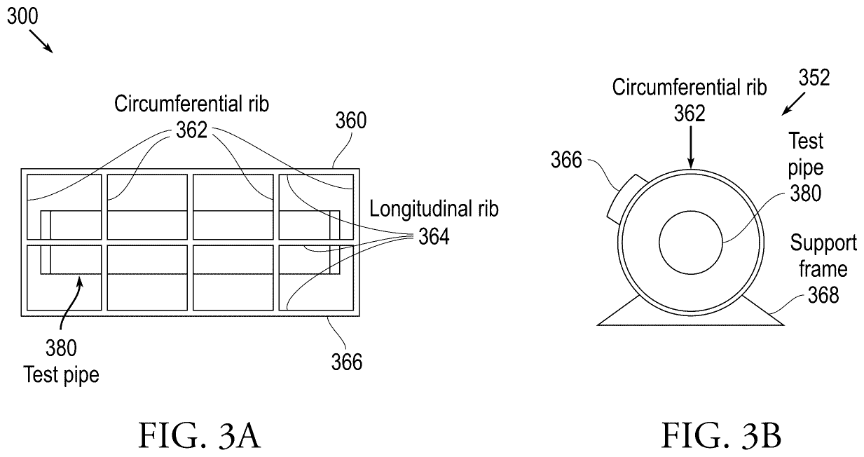

FIG. 3A is a side view 300 of a cylindrical rigid frame 366 (similar to rigid frame structure 166 in FIG. 1) composed of longitudinal ribs 364 and circumferential ribs 362 consistent with one or more embodiments of the present disclosure. FIG. 3B is a cross-sectional view 352 of a cylindrical rigid frame 366 of a blast-resistant enclosure 360 (similar to blast-resistant enclosure 160 in FIG. 1) composed of longitudinal ribs 364 and circumferential ribs 362 consistent with one or more embodiments of the present disclosure.

In one or more implementations, to enhance the versatility and effectiveness of the blast-resistant enclosure 360, a plurality of such enclosures are employed. In situations where extreme conditions or higher levels of protection are anticipated, a single enclosure may not suffice. By allowing for the addition of multiple armor layers (such as armor layer 130 in FIG. 1) and cushion layers (such as cushion layer 140 in FIG. 1) within a single enclosure 360, or by interconnecting several enclosures 360, the design can be tailored to meet specific operational demands while optimizing safety. This type of approach provides a scalable solution suitable for varied applications, where additional layers are configured based on the assessed risk levels or testing requirements.

In some implementations, there are a plurality of blast-resistant enclosures 360. In some implementations, an apparatus consistent with the present disclosure further comprises at least one test pipe 380 interconnecting at least two of the plurality of blast-resistant enclosures 360. In various implementations, a support frame 368 holds the enclosure 360 in place. In one or more implementations, the blast-resistant enclosure 360 is attached to a rigid frame structure 366. FIG. 3 shows an example of a rigid frame structure 366, depicting a cylindrical frame composed of longitudinal ribs 364 and circumferential ribs 362 along with a supporting frame 368. In some implementations, the blast-resistant enclosure 360 is affixed inside the rigid frame structure 366.

In some implementations, a pressure testing apparatus comprises a blast-resistant enclosure 360. In some variations, the blast-resistant enclosure houses typical pressure testing components, further comprising one or a number of the following: a pressure pump, pressure controller, pressure gauge, pressure safety valve, vent valve, water tank, test pipe (such as test pipe 380), and end closures. One of the goals of the blast-resistant enclosure 360 is to protect employees and nearby assets by containing high-pressure releases and debris resulting from component bursts.

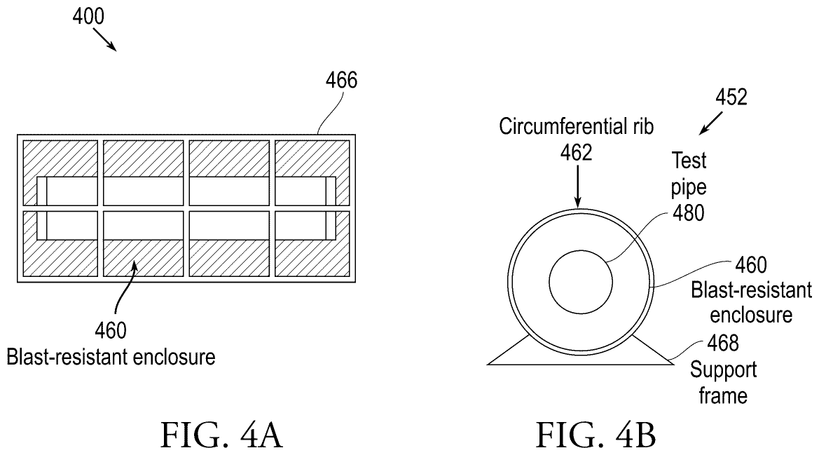

FIG. 4A is a side view 400 of a hydrotest pressure testing and condition monitoring assembly with a blast-resistant enclosure 460 (similar to blast-resistant enclosure 160 in FIG. 1) consistent with one or more embodiments of the present disclosure. FIG. 4B is a cross-sectional view 452 of a hydrotest pressure testing and condition monitoring assembly with a blast-resistant enclosure 460 consistent with one or more embodiments of the present disclosure.

In some implementations, the blast-resistant enclosure 460 comprises a rigid frame 466 (similar to rigid frame structure 166 in FIG. 1) composed of longitudinal ribs 464 and circumferential ribs 462. In various implementations, a support frame 468 (similar to support frame 368 in FIG. 3) holds the enclosure 460 in place. In some implementations, an apparatus consistent with the present disclosure further comprises at least one test pipe 480 (similar to test pipe 380 in FIG. 3) intersecting or interconnecting one or more blast-resistant enclosures 460. FIG. 4 is a pressure testing and condition monitoring assembly according to one or more implementations of the present disclosure and features the blast-resistant enclosure 460, indicating that the blast-resistant enclosure 460 is attached inside a cylindrical rigid frame 466. In one or more variants, the blast-resistant enclosure 460 is implemented as a single piece, while in additional variants the blast-resistant enclosure 460 is implemented as multiple pieces. In various arrangements, multiple blast-resistant pads are affixed to the rigid frame structure.

In various arrangements, the blast-resistant enclosure 460 is constructed from multi-layered materials. These multi-layered materials consist, in some instances, of an armor layer (such as armor layer 130 from FIG. 1) for structural integrity and impact resistance; a cushion layer (such as cushion layer 140 from FIG. 1) for energy dampening; and a cover layer (such as cover layer 150 from FIG. 1) for protection from environmental factors.

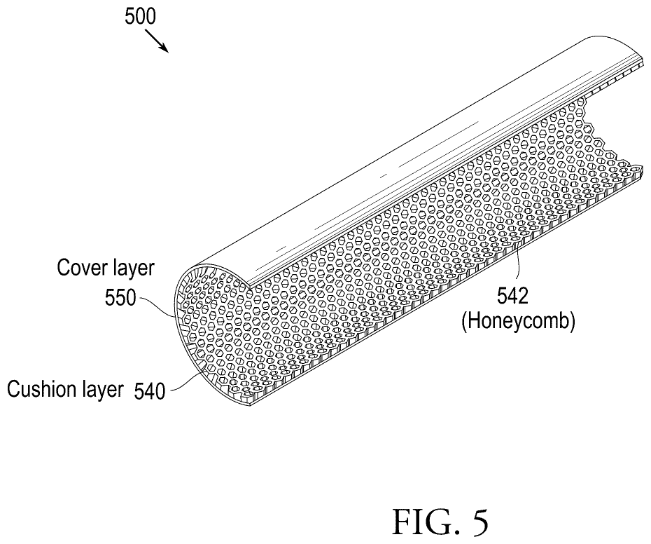

FIG. 5 is a depiction 500 of a cushion layer 540 (similar to cushion layer 140 in FIG. 1) in a blast-resistant enclosure consistent with one or more embodiments of the present disclosure. In some implementations, the cushion layer 540 is surrounded by a cover layer 550 (similar to cover layer 150 in FIG. 1). In one or more implementations, a honeycomb structure 542 or other energy-dampening structure is used as a design for the internal cushion layer 540.

FIG. 5 is a honeycomb cushion layer 540 within the blast-resistant enclosure (such as blast-resistant enclosure 160 in FIG. 1), according to one or more implementations of the present disclosure. In FIG. 5, in order to show the cushion layer 540, the inner armor layer is omitted, but it should be appreciated that in practical embodiments, the cushion layer 540 is sandwiched between an armor layer and the cover layer 550.

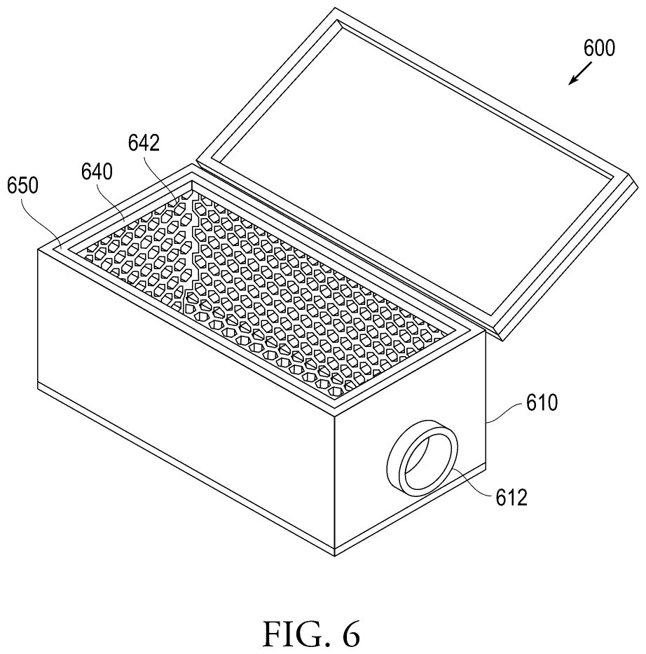

FIG. 6 is a depiction 600 of a blast-resistant enclosure lined in a hard casing 610 consistent with one or more embodiments of the present disclosure. In one or more variations, a rigid frame of the blast-resistant enclosure further comprises a hollow cylindrical structure 612 extending from within the blast-resistant enclosure to an exterior thereof. In some implementations, the hollow cylindrical structure 612 is configured to receive a test pipe of one or more different diameters.

In some implementations, the blast-resistant enclosure comprises a hard casing 610 further comprising one of the multiple layers of material (such as cushion layer 140 in FIG. 1). In various implementations, a honeycomb structure 642 or other energy-dampening structure is used as a design for an internal cushion layer. In some arrangements, the hard casing 610 has openings for the insertion and extraction of a test pipe, such as test pipe 380 in FIG. 3.

In one or more implementations, a blast-resistant enclosure is lined onto a hard case, such as hard case 610. FIG. 6 is an example of such a lining. For visual clarity in FIG. 6 of the cushion layer 640 (similar to cushion layer 140 in FIG. 1) sandwiched between an armor layer (such as armor layer 130 in FIG. 1) and the cover layer 650 (similar to cover layer 150 in FIG. 1), the inner armor layer was removed. In some implementations, the case 610 may have openings on two opposite sides (with opening 612 being one such opening), enabling the test pipe (such as test pipe 380 in FIG. 3) to slide in and out.

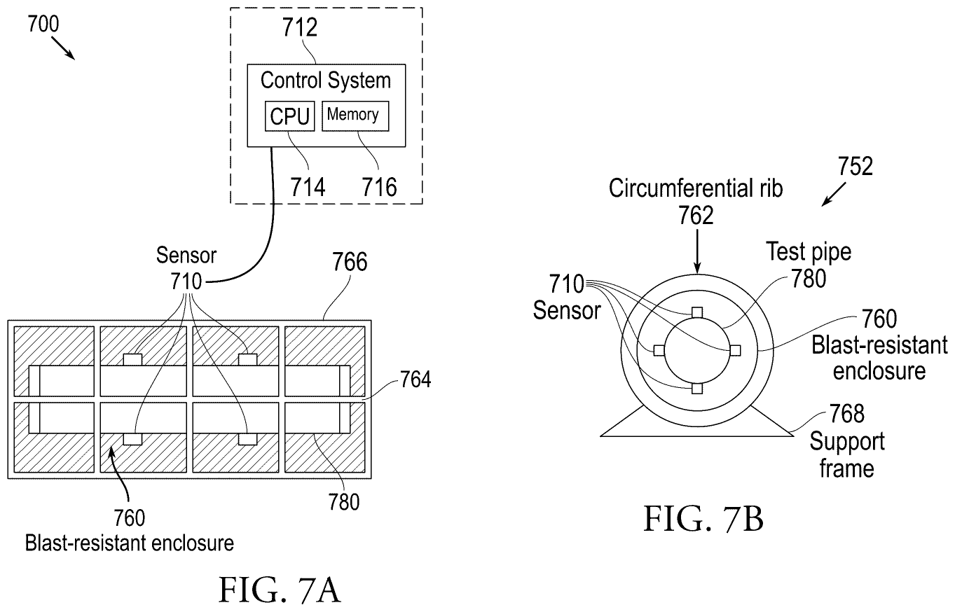

FIG. 7A is a side view 700 of a hydrotest pressure testing and condition monitoring assembly with sensors 710 installed onto a test pipe 780 (similar to test pipe 380 in FIG. 3) consistent with one or more embodiments of the present disclosure. FIG. 7B is a cross-sectional view 752 of a hydrotest pressure testing and condition monitoring assembly with sensors 710 installed onto a test pipe 780 consistent with one or more embodiments of the present disclosure.

In some implementations, a blast-resistant enclosure 760 (similar to blast-resistant enclosure 160 in FIG. 1) comprises a rigid frame 766 (similar to rigid frame structure 166 in FIG. 1) composed of longitudinal ribs 764 and circumferential ribs 762. In various implementations, a support frame 768 (similar to support frame 368 in FIG. 3) holds the enclosure 760 in place. In some implementations, an apparatus consistent with the present disclosure further comprises at least one test pipe 780 intersecting or interconnecting one or more blast-resistant enclosures 760.

In various arrangements, apparatuses consistent with the present disclosure further comprise a plurality of pipe condition monitoring sensors 710 respectively associated with respective ones of the at least one test pipe 780. In one or more implementations, a pressure testing and condition monitoring assembly, like pressure testing and condition monitoring assembly 170 in FIG. 1, further comprises a plurality of pipe condition monitoring sensors 710. The pipe condition monitoring sensors 710 are supported by a test pipe 780, within the enclosure 760, or both supported by a test pipe 780 and within the enclosure 760.

In one or more variants, the pipe condition monitoring sensors 710 comprise one or more acoustic emission sensors configured to detect crack initiation and propagation within the enclosure. In some implementations of sensors consistent with the present disclosure, and in the context of the exemplary implementation in FIG. 7, the integration of a control system 712 within the pipeline condition monitoring assembly (such as pipeline conditioning monitoring assembly 170 in FIG. 1) enhances the operational effectiveness of the sensor arrangements. Specifically, the control system 712 comprises a processor 714, a memory 716, and executable code stored in the memory 716 to manage and interpret the data gathered from the plurality of pipe condition monitoring sensors 710 installed on the test pipe 780 (or otherwise arranged within the blast-resistant enclosure 760.

In some implementations, these sensors 710, which include acoustic emission sensors configured to detect crack initiation and propagation within the enclosure, rely on the control system 712 for their functionality. The processor 714 (or “CPU”) is programmed with code that executes therein to analyze output signals generated by the sensors 710, coordinating actions such as alerting personnel when critical thresholds are reached. Furthermore, in one or more implementations, the control system 712's development architecture leverages the relationship between the sensors 710 and the processor 714, whereby their configuration as part of an integrated circuit enables real-time monitoring and diagnostics of pipe integrity during testing procedures. In some implementations, this comprehensive arrangement ensures that the components do not independently assess conditions; rather, it is their systematic organization, defined by both hardware and software configurations, that enables effective monitoring and response capabilities. It is to be understood that such a control system 712 is integrable with any other descriptions, implementations, embodiments, and figures of the present disclosure.

In some implementations, multiple acoustic emission sensors 710 are installed on the test pipe 780 and are configured by code executing in a processor or by associated circuitry to study fracture mechanics by analyzing crack initiation and propagation data obtained from the sensors 710. Pipe condition monitoring sensors 710 facilitate precise monitoring of pipe damage at different stages. In particular arrangements, the sensors 710 comprise, but are not limited to, acoustic emission sensors, strain gauges, and microwave sensors. For example, in some implementations, multiple acoustic emission sensors 710 are installed on the test pipe 780, as shown in FIG. 7, facilitating the study of fracture mechanics through the analysis of crack initiation and propagation data obtained from the sensors 710. In one or more variations, strain gauges are placed in multiple locations on the test pipe 780 to monitor local deformation during a hydrotest. Some implementations comprise a combination of sensors and sensor types on both the test pipe 780 and the enclosure 760.

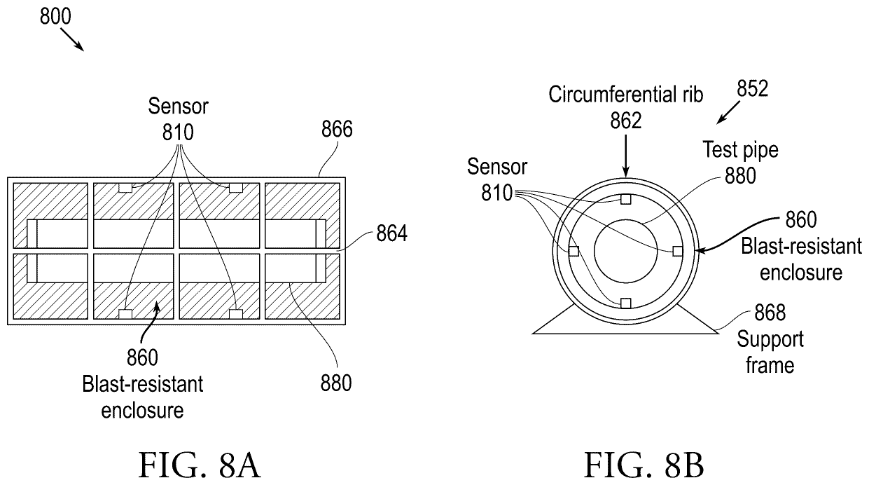

FIG. 8A is a side view 800 of a hydrotest pressure testing and condition monitoring assembly with sensors 810 (similar in some respects to sensors 710 in FIG. 7) installed onto walls of an enclosure 860 (similar to blast-resistant enclosure 160 in FIG. 1) consistent with one or more embodiments of the present disclosure. FIG. 8B is a cross-sectional view 852 of a hydrotest pressure testing and condition monitoring assembly with sensors 810 installed onto walls of an enclosure 860 consistent with one or more embodiments of the present disclosure.

In some implementations, a blast-resistant enclosure 860 comprises a rigid frame 866 (similar to rigid frame structure 166 in FIG. 1) composed of longitudinal ribs 864 and circumferential ribs 862. In various implementations, a support frame 868 (similar to support frame 368 in FIG. 3) holds the enclosure 860 in place. In some implementations, an apparatus consistent with the present disclosure further comprises at least one test pipe 880 (similar to test pipe 380 in FIG. 3) intersecting or interconnecting one or more blast-resistant enclosures 860.

In some variants, the pipe condition monitoring sensors 810 comprise one or more microwave nondestructive testing sensors embedded within the walls of the blast-resistant enclosure 860. The microwave nondestructive testing sensors 810 are configured to monitor for defects. In particular arrangements, multiple microwave nondestructive sensors 810 are installed inside the blast-resistant enclosure 860, facilitating close monitoring of existing and new defects such as delamination, voids, and fiber breakage. In one or more variations, the microwave sensors 810 are embedded within the wall structure of the enclosure 860, providing better protection from flying debris resulting from a pipe burst. In one or more variants, by combining various sensors (such as sensors 710 from FIGS. 1 and 810 from FIG. 8) in the pressure testing and condition monitoring assembly (such as pressure testing and condition monitoring assembly 170 in FIG. 1), researchers can achieve in-depth investigations into the pipe fracture mechanisms under pressure.

In one or more implementations, multiple microwave nondestructive sensors 810 are installed inside the blast-resistant enclosure, as illustrated in FIG. 8. This arrangement of sensors 810 facilitates close monitoring of existing and new defects, such as delamination, voids, and fiber breakage, throughout conduction of a pressure test. In some variants, to protect the microwave sensors 810 from flying debris during burst failure, the sensors 810 are embedded within the walls of the blast-resistant enclosure 860.

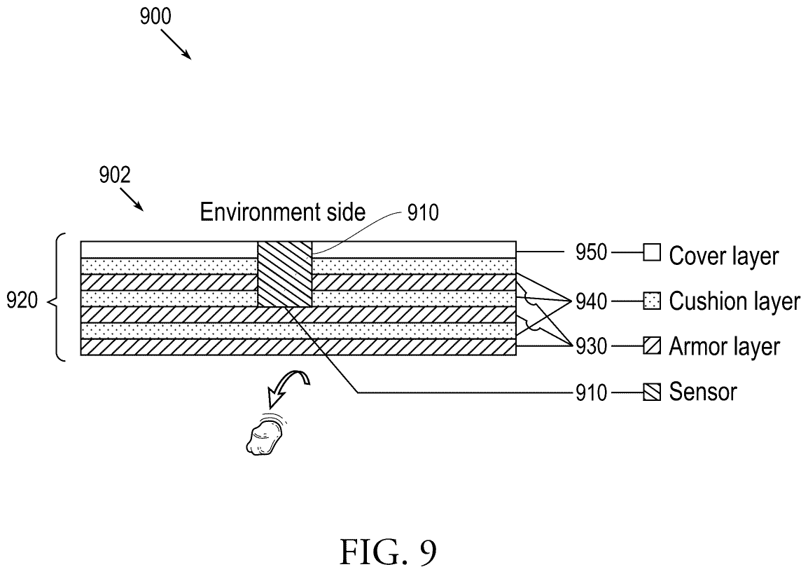

FIG. 9 is a depiction 900 of a wall structure 902 (similar to wall structure 102 in FIG. 1) of a blast-resistant enclosure with sensors 910 (similar in some respects to sensors 710 in FIG. 7) embedded inside the enclosure, consistent with one or more embodiments of the present disclosure. The wall structure 902 has multiple internal layers 920. There are three cushion layers 940 (each similar to cushion layer 140 in FIG. 1) and three armor layers 930 (each similar to armor layer 130 in FIG. 1), all encased by a cover layer 950 (similar to cover layer 150 in FIG. 1). Some implementations are constructed to have even more of each type of layer.

In some implementations, the armor layers 930 and the cushion layers 940 are arranged in sequence, with an armor layer 930 facing the high-pressure equipment. In one or more implementations, an armor layer 930 provides necessary structural integrity against high-energy releases during bursts, as well as impact resistance against high-velocity debris. In particular arrangements, the cushion layers 940 are positioned behind an armor layer 930, absorbing the majority of the impact energy through material deformation. In various arrangements, the cushion layer 940 is soft and susceptible to mechanical damage if exposed to high-kinetic-energy debris. By placing the armor layer 930 in front, the cushion layer 940 is shielded from mechanical damage. In one or more variants, a protective cover layer 950 is added to the environmental side of the blast-resistant enclosure to prevent UV damage, abrasion, and other mechanical damage.

In some variants, to protect sensors, such as sensor 910, from flying debris during burst failure, sensors 910 are embedded within the walls, such as wall 902, of the blast-resistant enclosure, as depicted in FIG. 9. In various arrangements, armor layers 930 and cushion layers 940 are positioned before the sensors 910, so the embedded sensors 910 are safeguarded from flying debris and energy release. In one or more variations, microwave signals emitted from the sensors 910 penetrate any nonmetallic layers 920 of the enclosure, which promotes accurate data collection and analysis.

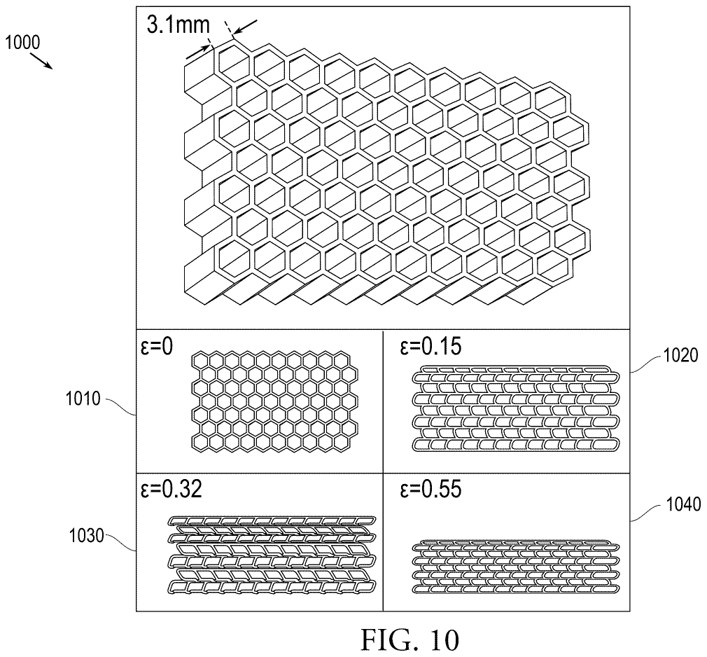

FIG. 10 depicts an energy dampening honeycomb structure 1000 consistent with one or more embodiments of the present disclosure. In one or more variations, energy dampening is accomplished through a unique material property known as viscoelasticity; viscoelastic materials store some of the energy generated during a load, with the remaining energy dissipating as heat. In some implementations of energy dampening consistent with the present disclosure, energy dampening is further enhanced by incorporating specialized structures such as honeycombs, cellular foams, and interpenetrating polymer networks. The panels in FIG. 10 represent increasing strain (ε) values, with 1010 being ε=0, 1020 being ε=0.15, 1030 being ε=0.32, and 1040 being ε=0.55. As shown in FIG. 10, the honeycomb structure used in various implementations of the present disclosure is deformable to a significant degree without causing damage to its structure. In some implementations of the present disclosure, an exemplary side length for one of the hexagons comprising the honeycomb structure is 3.1 mm. In other implementations, the sizes and dimensions of the energy dampening structures are tailored to fit specific design requirements and application variables.

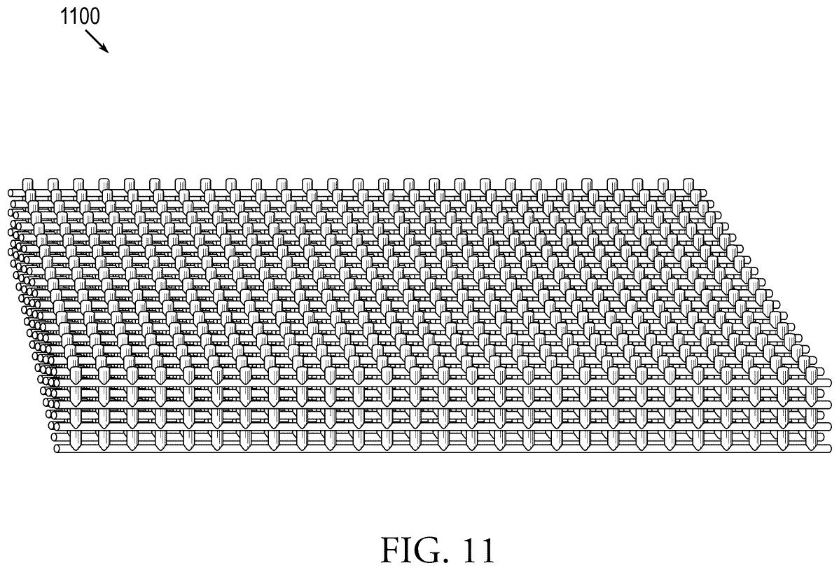

FIG. 11 depicts an energy dampening cellular foam structure 1100 consistent with one or more embodiments of the present disclosure. Exemplary energy dampening structures for use in various implementations consistent with the present disclosure are depicted in FIGS. 10 and 11.

Conventional hydrotest systems in some cases require a minimum distance of, for example, 50 feet and involve daunting safety measures. A pneumatic test of conventional systems can introduce a higher risk of catastrophic failure due to greater stored energy. Apparatuses and methods consistent with the present disclosure ensure that the released energy and debris from component failure is safely contained, thus eliminating the need for large spaces. In addition to the aforementioned design considerations, energy dampening structures such as honeycomb and cellular foam within the cushion layer (such as cushion layer 140 in FIG. 1) are intended to deform significantly upon impact, thereby absorbing substantial kinetic energy while maintaining the integrity of the overall enclosure structure.

The versatility in design for these energy dampening mechanisms offers substantial capacity for customization, allowing the selection of specific configurations that influence the energy dampening capability tailored to the operational setting. For instance, exemplary weights of these energy dampening layers vary in some implementations, with values typically falling within the range of approximately 0.5 to 3.0 pounds per square foot, depending on the thickness and material used. Additionally, specific dimensions for the honeycomb structures, as illustrated in FIGS. 10 and 11, are optimizable—common dimensions include hexagonal cells with side lengths ranging from 3 to 15 millimeters, allowing for effective energy absorption in alignment with varying testing requirements and safety protocols. This adaptability in design aids in meeting the diverse practical demands associated with high-pressure testing scenarios.

The present disclosure enables significant energy to be absorbed by an energy dampening cushion layer (such as cushion layer 140 in FIG. 1), enabling a lighter design of the structural armor layer (such as armor layer 130 in FIG. 1) while leading to substantial cost savings. Flying debris from component bursts often retain high kinetic energy after impacting a protective wall, due to limited energy dampening capabilities. This often causes secondary damage to test components, obscuring the true failure mode stemming from the burst. The multi-layered design of the present disclosure, however, results in the flying debris losing most of its kinetic energy, alleviating concerns regarding secondary damage. In some implementations, applications of the present disclosure extend beyond pressure testing; various implementations can also be utilized for any high-pressure assets.

It is to be understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An apparatus for pressure testing, comprising:
a blast-resistant enclosure comprising multiple layers of material;
an armor layer among the multiple layers of material, the armor layer being configured to provide structural integrity and impact resistance, and
a cushion layer among the multiple layers of material, the cushion layer being configured to dampen energy, and
a cover layer disposed over the other layers of material comprising the blast-resistant enclosure; and
a pressure testing and condition monitoring assembly positioned within the blast-resistant enclosure.

2. The apparatus of claim 1, wherein the armor layer comprises a material selected from the group consisting of: aramid fiber, ultra-high molecular weight polyethylene fiber, polycarbonate, and meshed metal sheets.

3. The apparatus of claim 1, wherein the cushion layer comprises a plurality of pores configured to enhance energy dampening, utilizing a structure selected from the group consisting of:
honeycomb, cellular foam, and interpenetrating polymer network materials.

4. The apparatus of claim 1, wherein the wherein the cushion comprises a material selected from the group consisting of: rubber and polyurethane.

5. The apparatus of claim 1, wherein there are a plurality of blast-resistant enclosures, further comprising at least one test pipe interconnecting at least two of the plurality of blast-resistant enclosures.

6. The apparatus of claim 5, further comprising a plurality of pipe condition monitoring sensors respectively associated with respective ones of the at least one test pipe.

7. The apparatus of claim 1, wherein the pressure testing and condition monitoring assembly further comprises a plurality of pipe condition monitoring sensors, and wherein the pipe condition monitoring sensors are supported by a test pipe, within the enclosure, or both supported by a test pipe and within the enclosure.

8. The apparatus of claim 1, wherein the pressure testing and condition monitoring assembly further comprises a plurality of pipe condition monitoring sensors, and wherein the pipe condition monitoring sensors comprise one or more acoustic emission sensors configured to detect crack initiation and propagation within the enclosure.

9. The apparatus of claim 1, wherein the pressure testing and condition monitoring assembly further comprises a plurality of pipe condition monitoring sensors, wherein the pipe condition monitoring sensors comprise one or more microwave nondestructive testing sensors attached onto, supported by, and/or embedded within the walls of the blast-resistant enclosure, and wherein the microwave nondestructive testing sensors are configured to monitor for defects.

10. The apparatus of claim 1, further comprising a rigid frame structure coupled to the blast-resistant enclosure, the rigid frame structure comprising a hollow cylindrical structure extending from within the blast-resistant enclosure to an exterior thereof, wherein the hollow cylindrical structure is configured to receive a test pipe of one or more different diameters.

11. The apparatus of claim 1, further comprising a test pipe, and wherein the blast-resistant enclosure is lined with a hard casing comprising one of the multiple layers of material, wherein the hard casing has openings for the insertion and extraction of the test pipe.

12. A method for conducting a pressure test in an enclosure, comprising:
providing a blast-resistant enclosure made of a multi-layered material comprising an armor layer configured to provide structural integrity and impact resistance, a cushion layer configured to dampen energy, and a cover layer disposed over the other layers of material comprising the blast-resistant enclosure;
positioning a pressure testing and condition monitoring assembly within the blast-resistant enclosure; and
activating the pressure testing and condition monitoring assembly.

13. The method of claim 12, further comprising the following steps:
fabricating the armor layer from a material selected from the group consisting of the following: aramid fiber, ultra-high molecular weight polyethylene fiber, polycarbonate, and meshed metal sheets; and
incorporating a cushion layer that comprises pores configured to enhance energy dampening, utilizing a structure selected from the group consisting of the following: honeycomb, cellular foam, and interpenetrating polymer network materials.

14. The method of claim 12, further comprising configuring the cover layer of the blast-resistant enclosure to provide protection against one or more of UV radiation, abrasion, and mechanical damage.

15. The method of claim 12, further comprising the following steps:
providing one or more additional blast-resistant enclosures resulting in a plurality of blast-resistant enclosures,
interconnecting, via at least one test pipe, at least two of the plurality of blast-resistant enclosures.

16. The method of claim 15, further comprising installing a plurality of pipe condition monitoring sensors within the blast-resistant enclosure and/or supported by the at least one test pipe.

17. The method of claim 12, further comprising utilizing a pressure testing and condition monitoring assembly that incorporates a plurality of pipe condition monitoring sensors supported by a test pipe, within the enclosure, or both.

18. The method of claim 12, further comprising detecting, via one or more acoustic emission sensors within the pressure testing and condition monitoring assembly, crack initiation and propagation within the enclosure.

19. The method of claim 12, further comprising monitoring defects in the enclosure via one or more microwave nondestructive testing sensors embedded within the walls of the blast-resistant enclosure.

20. The method of claim 12, further comprising accommodating different diameters of test pipes insertable into the rigid frame via a cylindrical rigid frame structure.
